(19) United States
(12) Patent Application Publication
(10) Pub. No.: US 2008/0125039 A1
(43) Pub. Date: May 29, 2008

(54) VIRTUAL SHORT RANGE INTERFACE FOR LONG RANGE WIRELESS COMMUNICATION

(76) Inventor: Michael F. Glinka, Nuremberg (DE)

Correspondence Address: MARK W. SINCELL;Williams, Morgan & Amerson, P.C., Suite 1100, 10333 Richmond, Houston, TX, 77042, US

(21) Appl. No.: 11/563,963

(22) Filed: Nov. 28, 2006

(51) Int. Cl. H04B 7/00

(52) U.S. Cl. 455/41.2

(57) ABSTRACT

The present invention provides a method involving at least one device belonging to a defined set in which a plurality of devices communicate with each other. The method includes encoding first information according to a first protocol for transmissions over at least one first air interface between at least two of the plurality of devices in the defined set. The method also includes forming second information for transmission according to a second protocol. The second information includes the first information. The method further includes transmitting the second information over a second air interface according to the second protocol.

### CROSS REFERENCE TO RELATED APPLICATIONS

This application is related to U.S. patent application Ser. No. 11/549,716, filed on Oct. 16, 2006.

### BACKGROUND OF THE INVENTION

1. Field of the Invention

This invention relates generally to communication systems, and, more particularly, to wireless communication systems.

2. Description of the Related Art

Short-range air interfaces have been developed to support communication between devices that typically remain relatively close to each other. The Bluetooth short-range air interface supports wireless communication between devices that are separated by a distance of up to approximately 100 meters. For example, Bluetooth supports at least three different classes of communication that are distinguished based on the transmission power and device separation: class 3 supports a transmission power of about 1 milliwatt for distances of up to about 3.3 feet (1 meter), class 2 supports a transmission power of about 10 milliwatts for distances of up to about 33 feet (10 meters), and class 1 supports a transmission power of about 100 milliwatts for distance of up to about 328 feet (100 meters). Bluetooth has been implemented in a wide variety of devices including keyboards, computer mice, headphones, earpieces, and other peripheral devices, as well as cellular telephones, smart phones, personal data assistants, notebook computers, desktop computers, and the like.

Short-range air interfaces have a number of advantages over long-range air interfaces such as radiofrequency air interfaces used for cellular voice and/or data communication. For example, the transmitters typically require substantially less power and the receivers may be less sensitive than the corresponding devices used for long-range air interfaces. However, short-range air interfaces also have a number of drawbacks. For example, short-range air interfaces such as Bluetooth are, almost by definition, limited to supporting communications over much shorter distances than are available for communications over long-range air interfaces. At least in part because of the range limitations of short-range air interfaces such as Bluetooth, communications over short-range air interfaces are not typically supported by networks such as the core network in a Universal Mobile Telecommunication System (UMTS) wireless communication system. Thus, devices that implement short-range air interfaces cannot exploit the vast majority of existing (and future) network infrastructure.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided involving at least one device belonging to a defined set in which a plurality of devices communicate with each other. The method includes encoding first information according to a first protocol for transmissions over at least one first air interface between at least two of the plurality of devices in the defined set. The method also includes forming second information for transmission according to a second protocol. The second information includes the first information. The method further includes transmitting the second information over a second air interface according to the second protocol.

In another embodiment of the present invention, a method is provided involving at least one device belonging to a defined set in which a plurality of devices communicate with each other. The method includes accessing first information transmitted over a first air interface according to a first protocol. The first information includes second information encoded according to a second protocol for transmissions over at least one second air interface between at least two of the plurality of devices in the defined set. The method also includes extracting the second information from the first information.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a first exemplary embodiment of a wireless communication system, in accordance with the present invention;

FIG. 2 conceptually illustrates a second exemplary embodiment of a wireless communication system, in accordance with the present invention; and

FIG. 3 conceptually illustrates a third exemplary embodiment of a wireless communication system, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

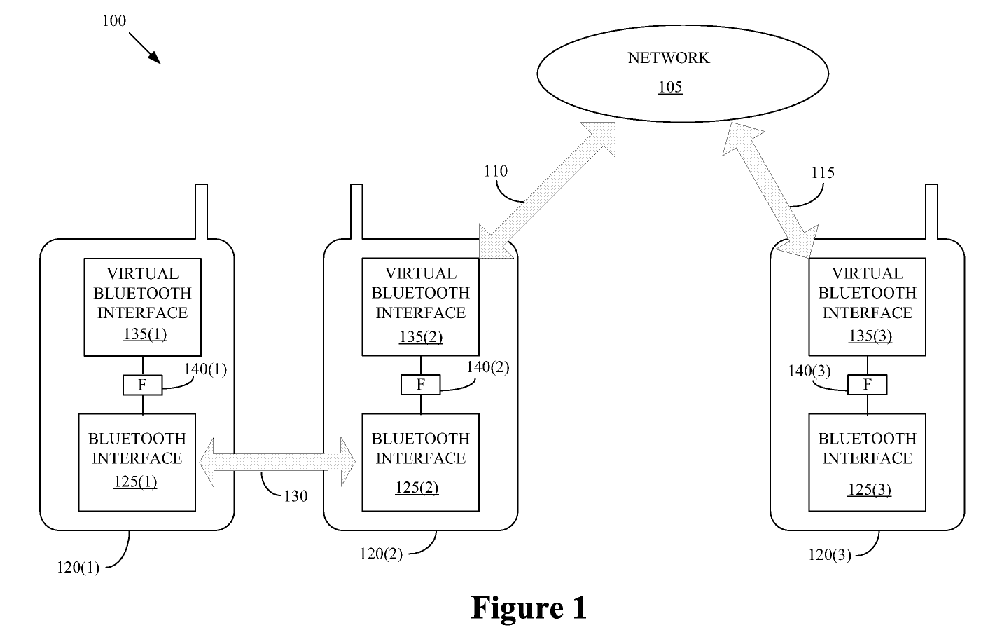

FIG. 1 conceptually illustrates a first exemplary embodiment of a wireless communication system 100. In the illustrated embodiment, the wireless communication system 100 includes a core network 105 that supports communication over long-range air interfaces 110, 115. Long-range air interfaces are typically able to exchange signals over long distances. For example, a long-range air interface that operates according to UMTS standards and/or protocols may permit communication over distances of up to about 10 km. For another example, a long-range air interface that operates according to WiMAX standards and/or protocols may permit communication over distances in excess of 20 km. The network 105 may also be capable of supporting virtually any number of long-range air interfaces 110, 115 and the number of long-range air interfaces 110, 115 that may be supported by a network 105, as well as the particular devices that utilize these interfaces, may not need to be defined. Accordingly, any device capable of communicating over the long-range air interfaces 110 115 may access the network 105. Exemplary long-range air interfaces include, but are not limited to, the radiofrequency interfaces supported by the standards and/or protocols defined by one or more of the Universal Mobile Telecommunication System (UMTS), Code Division Multiple Access (CDMA, CDMA 2000), the Global System for Mobile communications (GSM), WiMAX, and the like.

The first embodiment of the wireless communication system 100 also includes one or more mobile units 120(1-3). The indices (1-3) may be used to indicate individual mobile units 120(1-3) or subsets thereof. However, these indices may be dropped when the mobile units 120 are referred to collectively. This convention may also be applied to other elements in the drawings that are indicated by a numeral and one or more distinguishing indices. Exemplary mobile units include, but are not limited to, cellular telephones, personal data assistants, smart phones, text messaging devices, pagers, global positioning system (GPS) devices, network interface cards, notebook computers, and desktop computers. Although three mobile units 120 are depicted in FIG. 1, persons of ordinary skill in the art having benefit of the present disclosure should appreciate that the present invention is not limited to any particular number of mobile units 120.

The mobile units 120 are configured to communicate with other mobile units 120 (or other devices) in a defined set using one or more protocols for establishing air interfaces between the mobile units 120 in the defined set. These types of communication protocols for defined sets of devices have been developed to provide reliable, high quality communication networks in constrained settings such as building interiors. For example, the Bluetooth standard is commonly used to implement short distance wireless networks having a defined set of member devices, which are sometimes referred to as piconets. Bluetooth compatible devices transmit data and/or voice over an air interface, or wireless communication link, in the Industrial, Scientific, and Medical (ISM) frequency band at about 2.4 GHz using a frequency-hopping technique. Due in part to the frequency-hopping characteristics of the Bluetooth standard, the communication link formed according to the Bluetooth standard has a reasonable chance of maintaining link quality in the presence of interference. The Bluetooth standard is well known to persons of ordinary skill in the art, and so, in the interest of clarity, only those aspects of the Bluetooth standard that are relevant to the present invention will be discussed herein.

In the illustrated embodiment, the mobile units 120 include Bluetooth interfaces 125 for communicating with other mobile units 120 within an associated piconet. For example, the mobile units 120(1-2) may form a piconet and may therefore communicate by transmitting signals that have been encoded according to the Bluetooth protocol over an air interface 130. The mobile units 120(1-2) may also communicate with other devices within the piconet. For example, the mobile unit 120(2) may establish a wireless communication link with a wireless earpiece (not shown) using the Bluetooth interface 125(2). However, the present invention is not limited to Bluetooth interfaces 125. In alternative embodiments, other interfaces 125 for communication with a defined set of devices, such as interfaces defined by the IEEE 802 standards or protocols, may be implemented in the present invention.

The mobile units 120 also include a virtual Bluetooth interface 135 that enables the mobile units 120 to exchange information encoded according to the Bluetooth protocol over air interfaces that operate according to long-range protocols, such as UMTS, GSM, WiMAX, and the like. The virtual Bluetooth interface 135 may be implemented using hardware, firmware, software or any combination thereof. Moreover, persons of ordinary skill in the art having benefit of the present disclosure should appreciate that in alternative embodiments the mobile units 120 may include other virtual interfaces for exchanging information encoded according to other defined-set protocols over air interfaces that operate according to long-range protocols. The virtual Bluetooth interface 135 may access or receive information that is encoded according to the Bluetooth protocol. For example, information encoded according to the Bluetooth protocol may be provided to the virtual Bluetooth interface 135 by a conventional Bluetooth interface 125. Alternatively, the virtual Bluetooth interface 135 may receive information that is not encoded according to the Bluetooth protocol and may then encode this information according to the Bluetooth protocol. In one embodiment, the virtual Bluetooth interface 135 and a conventional Bluetooth interface 125 may be separated by a firewall 140, which may provide additional security.

The virtual Bluetooth interface 135 may then use the Bluetooth-encoded information to form signals or information that may be transmitted over a long-range air interface 110, 115. In one embodiment, the virtual Bluetooth interface 135 may encapsulate the Bluetooth-encoded information in the bodies of one or more packets that are formed according to one or more long-range air interface protocols. The information that is encoded according to the long-range air interface protocols (e.g., one or more packets including the Bluetooth-encoded information) may then be transmitted over the long-range air interfaces 110, 115 to the network 105. For example, the mobile unit 120(3) may use the virtual Bluetooth interface 135(3) to transmit packets including Bluetooth-encoded information over the air interface 115 to the network 105 and then over the air interface 110 to the mobile unit 120(2).

The virtual Bluetooth interfaces 135 may receive signals and/or information that have been transmitted over a long-range air interface 110, 115 according to the associated long-range air interface protocols. The received signals and/or information may include information encoded according to the Bluetooth protocol (or some other defined-set protocol) and so the virtual Bluetooth interfaces 135 are configured to extract the Bluetooth-encoded information from the signals and/or information that are encoded according to the long-range air interface protocols. For example, the Bluetooth-encoded information may be included in a packet transmitted according to the long-range air interface protocols. Accordingly, the virtual Bluetooth interfaces 135 may be able to decode the packets and strip off any headers associated with the long-range air interface protocols to extract the Bluetooth-encoded information. This information may then be decoded according to the Bluetooth protocol and/or provided to other applications supported by the mobile unit 120. For example, the mobile unit 120(2) may receive packets including Bluetooth-encoded information over the air interface 110. The Bluetooth-encoded information may then be extracted by the virtual Bluetooth interface 135(2) and provided to the Bluetooth interface 125(2), which may then provide this information to the mobile unit 120(1) over the air interface 130.

Implementing the virtual Bluetooth interfaces 135 (or other virtual interfaces for other defined-set protocols) allows the mobile units 120 to overcome the distance restrictions associated with conventional defined-set protocols. For example, in the illustrated embodiment, using the virtual Bluetooth interfaces 135(2-3) to support Bluetooth communication via the network 105 may allow all of the mobile units 120 to be included in a single defined set or piconet. Thus, Bluetooth services may be provided to mobile units 120 distributed throughout any geographical area that permits access to the network 105 via a long-range air interface. The mobile units 120 may also be used as modems for other Bluetooth devices distributed in the geographical area served by the network 105. For example, a Bluetooth application in a mobile phone 120 may place a “phone call” via the network 105 to a Bluetooth GPS-mouse that is located far from the mobile phone 120. This long-range capability would enable companies to offer various data collection services. For example, companies may use the long-range of Bluetooth capability to implement online tracking of drive tests, remote collection of fleet control licenses from “RF-interface” covered areas (e.g., UMTS, CDMA, and GSM), or other Bluetooth services.

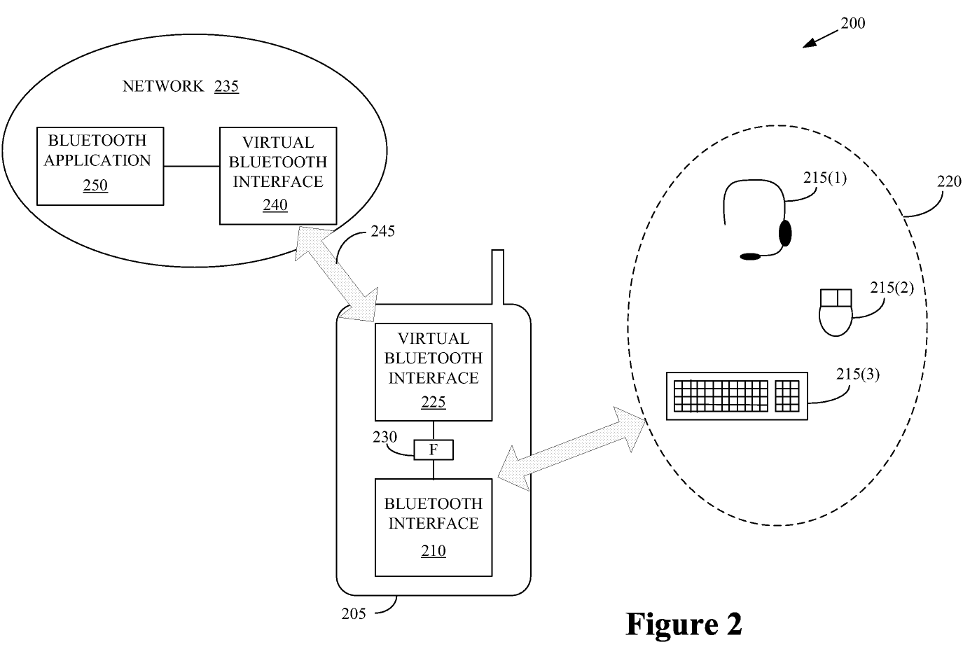

FIG. 2 conceptually illustrates a second exemplary embodiment of a wireless communication system 200. In the second exemplary embodiment, the system 200 includes one or more mobile units 205 (only one shown in FIG. 2). The mobile unit 205 is configured to communicate with other devices in a defined set using one or more protocols for establishing air interfaces between the devices in the defined set. In the illustrated embodiment, the mobile unit 205 includes a Bluetooth interface 210 for communicating with devices 215(1-3) within an associated piconet 220. For example, the mobile unit 205 may establish a wireless communication link with a wireless headset 215(1), wireless mouse 215(2), a wireless keyboard 215(3), or other devices (not shown) in the piconet 220 using the Bluetooth interface 210. However, the present invention is not limited to Bluetooth interfaces 210. In alternative embodiments, other interfaces 210 for communication with a defined set of devices, such as interfaces defined by the IEEE 802 standards or protocols, may be implemented in the present invention.

The mobile unit 205 also includes a virtual Bluetooth interface 225 that enables the mobile unit 205 to exchange information encoded according to the Bluetooth protocol over air interfaces that operate according to long-range protocols, such as UMTS, GSM, WiMAX, and the like. However, persons of ordinary skill in the art having benefit of the present disclosure should appreciate that in alternative embodiments the mobile unit 205 may include other virtual interfaces for exchanging information encoded according to other defined-set protocols over air interfaces that operate according to long-range protocols. The virtual Bluetooth interface 225 may access or receive information that is encoded according to the Bluetooth protocol. For example, information encoded according to the Bluetooth protocol may be provided to the virtual Bluetooth interface 225 by the conventional Bluetooth interface 210. Alternatively, the virtual Bluetooth interface 225 may receive information that is not encoded according to the Bluetooth protocol and may then encode this information according to the Bluetooth protocol. In one embodiment, the virtual Bluetooth interface 225 and a conventional Bluetooth interface 210 may be separated by a firewall 230, which may provide additional security.

The system 200 also includes a network 235 that supports wireless communication over air interfaces that operate according to one or more long-range protocols. The network 235 includes a virtual Bluetooth interface 240 that enables the network 235 to exchange information encoded according to the Bluetooth protocol (or other defined-set protocols) over an air interface 245 that operates according to the long-range protocol(s). Exemplary techniques for operating the virtual Bluetooth interface 240 to support the exchange of information encoded according to the Bluetooth protocol (or other defined-set protocols) over the air interface 245 are discussed elsewhere herein and in the interest of clarity will not be repeated here. The network 235 may therefore be able to support various Bluetooth services and/or applications 250 and provide these services to mobile units 205 and/or devices 215 that may be distributed over a relatively large geographic area. In one embodiment, the virtual Bluetooth interface 240 may be used to seamlessly connect Bluetooth ad hoc networks with any other networks over the Internet via the long-range air interfaces 245.

The virtual Bluetooth interface 240 may also be used to connect any other Bluetooth device with the Internet or to connect to any other Bluetooth interface from the Internet. For example, the Bluetooth application 250 may be a music listening service that transmits music according to the Bluetooth protocol. The virtual Bluetooth interface 240 can therefore access information representative of the transmitted music from the application 250 over the Internet, encode the Bluetooth information according to the long-range protocol, and transmit this information to the mobile unit 205 over the air interface 245. The virtual Bluetooth interface 225 may them provide this information to the conventional Bluetooth interface 210, which may transmit the Bluetooth-encoded information to the wireless headset 215(1) so that a user may listen to the transmitted music. For another example, a user may use the wireless mouse 215(2) and/or the wireless keyboard 215(3) to provide input to the Bluetooth application 250 via the Bluetooth interface 210, the virtual Bluetooth interface 225, the long-range air interface 245, and the virtual Bluetooth interface 240.

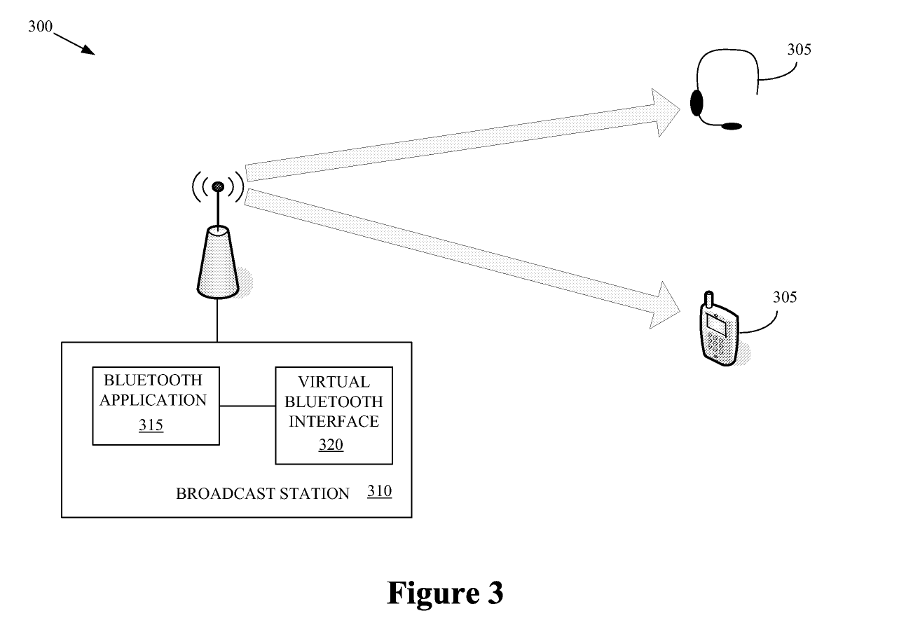

FIG. 3 conceptually illustrates a third exemplary embodiment of a wireless communication system 300. In the third exemplary embodiment, the system 300 includes one or more devices 305 configured to communicate with other devices in a defined set using one or more protocols for establishing air interfaces between the devices in the defined set. In the illustrated embodiment, the devices 305 include a Bluetooth interface (not shown) for establishing wireless communication links according to the Bluetooth protocol. However, the present invention is not limited to Bluetooth interfaces and/or protocols. In alternative embodiments, other interfaces for communication with a defined set of devices, such as interfaces defined by the IEEE 802 standards or protocols, may be implemented in the present invention. The third exemplary embodiment differs from the first and second exemplary embodiments in that the devices 305 may receive unidirectional transmissions via an internal virtual Bluetooth interface (not shown), instead of establishing a bidirectional communication link, as in the first and second exemplary embodiments.

In the illustrated embodiment, the system includes a broadcast station 310. Exemplary broadcast stations 310 include, but are not limited to, terrestrial radio stations, terrestrial television stations, and satellites for providing radio and/or television signals. The broadcast stations 310 may include a Bluetooth application 315 for generating the information and a virtual Bluetooth interface 320 for forming the unidirectional signals that are to be transmitted and/or broadcast. However, persons of ordinary skill in the art having benefit of the present disclosure should appreciate that the broadcast station 310 does not necessarily need to generate the content that is transmitted. Consequently, the Bluetooth application 315 is optional and may not be included in all embodiments of the broadcast station 310.

In one embodiment, the broadcast station 310 provides unidirectional beacon-like pilot transmissions such as satellite radio, TV or normal radio to the devices 305 using the virtual Bluetooth interface 320. For example, if the virtual Bluetooth interface 310 is in a satellite radio station 310, the virtual Bluetooth interface 310 may be able to drive the Bluetooth input of a HiFi amplifier or directly a Bluetooth driven headphone. Implementing a broadcast service using virtual Bluetooth, or other short range interfaces, may enable a TV or a radio station to reach a broad mass market of users that own Bluetooth enabled devices 305. These users can directly harness their Bluetooth headphones 305 to listen to music streams that are offered by TV or radio-stations. This technique may also be implemented for wireless internet access, where a Bluetooth audio stream may be derived from information accessed via the internet, such as web-radio.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method involving at least one device belonging to a defined set in which a plurality of devices communicate with each other, the method comprising:
encoding first information according to a first protocol for transmissions over at least one first air interface between devices in the defined set;
forming second information for transmission according to a second protocol, the second information comprising the first information; and
transmitting the second information over a second air interface according to the second protocol.

2. The method of claim 1, wherein encoding the first information comprises encoding the first information according to a Bluetooth protocol.

3. The method of claim 2, wherein encoding the first information according to a Bluetooth protocol comprises encoding the first information using at least one of a Bluetooth interface and a virtual emulated Bluetooth interface.

4. The method of claim 3, wherein encoding the first information comprises encoding the first information in at least one of a mobile unit and a core network.

5. The method of claim 1, wherein forming the second information comprises encoding second information according to a long-range wireless communication protocol.

6. The method of claim 1, wherein forming the second information comprises accessing the first information from a first interface that operates according to the first protocol.

7. The method of claim 6, wherein accessing the first information from the first interface comprises accessing the first information from the first interface via a firewall.

8. The method of claim 1, wherein transmitting the second information over the second air interface comprises transmitting the second information over a second air interface between a core network and at least one mobile unit.

9. The method of claim 1, wherein transmitting the second information over the second air interface comprises transmitting the second information over a second air interface that supports at least one of unidirectional and bidirectional communication.

10. A method involving at least one device belonging to a defined set in which a plurality of devices communicate with each other, the method comprising:
accessing first information transmitted over a first air interface according to a first protocol, the first information comprising second information encoded according to a second protocol for transmissions over at least one second air interface between devices in the defined set; and
extracting the second information from the first information.

11. The method of claim 10, wherein accessing the first information comprises accessing first information encoded according to a long-range wireless communication protocol.

12. The method of claim 11, wherein accessing the first information comprising the second information encoded according to a second protocol comprises accessing first information comprising second information encoded according to a Bluetooth protocol.

13. The method of claim 12, wherein accessing the first information comprising the second information comprises accessing first information comprising second information encoded using at least one of a Bluetooth interface and a virtual emulated Bluetooth interface.

14. The method of claim 13, wherein accessing the first information comprises accessing first information transmitted by at least one of a mobile unit and a core network.

15. The method of claim 10, comprising decoding the extracted the second information using the second protocol.

16. The method of claim 10, comprising transmitting the extracted second information over a second air interface that operates according to the second protocol.

17. The method of claim 16, wherein transmitting the extracted second information over the second air interface comprises transmitting the extracted second information over a second air interface between said at least one device in the defined set and at least one of a core network and another device in the defined set.

18. The method of claim 17, wherein transmitting the extracted second information over the second air interface comprises transmitting the extracted second information via a firewall.

19. The method of claim 10, wherein accessing the first information transmitted over the first air interface according to the first protocol comprises accessing the first information transmitted over a first air interface that supports at least one of unidirectional and bidirectional communication.
